(19) United States
(12) Patent Application Publication
(10) Pub. No.: US 2020/0069145 A1
(43) Pub. Date: Mar. 5, 2020

(54) METHOD FOR MONITORING USAGE OF A CONSUMABLE IN AN APPLIANCE

(71) Applicant: Haier US Appliance Solutions, Inc., Wilmington, DE (US)

(72) Inventor: Chad Michael Helms, Louisville, KY (US)

(21) Appl. No.: 16/115,672

(22) Filed: Aug. 29, 2018

(51) Int. Cl. A47L 15/00; G06K 7/10; D06F 33/02

(52) U.S. Cl. CPC A47L 15/0055; G06K 7/10861; D06F 33/02; D06F 2212/02; A47L 2401/023; A47L 2501/07; A47L 2501/26; A47L 15/006

(57) ABSTRACT

A method for monitoring usage of a consumable in an appliance includes optically scanning a consumable container with a reader of a mobile computing device, establishing a volume of consumable within the consumable container based upon the optical scan of the consumable container by the reader, determining a volume of consumable dispensed in an appliance, and activating a low consumable alert in response to a difference between the established volume of consumable and the determined volume of dispensed consumable being less than a threshold volume.

### FIELD OF THE INVENTION

The present subject matter relates generally to appliances that utilize consumables, such as detergent, fabric softener, rinse aid, dryer sheets, etc.

### BACKGROUND OF THE INVENTION

Certain appliances utilize a consumable during operation. For example, washing machine appliances and dishwasher appliances utilize detergent to wash articles. A user of such appliances generally purchases the consumable, and the user adds a volume of the consumable to the appliances each time that the appliances are started. Over time the supply of consumable is exhausted, and the user must purchase more for further operations of the appliances. Running out of the consumable prior to purchasing the replacement can be inconvenient.

### BRIEF DESCRIPTION OF THE INVENTION

Aspects and advantages of the invention will be set forth in part in the following description, or may be apparent from the description, or may be learned through practice of the invention.

In a first example embodiment, a method for monitoring usage of a consumable in an appliance includes optically scanning a consumable container with a reader of a mobile computing device, establishing a volume of consumable within the consumable container based upon the optical scan of the consumable container by the reader, determining a volume of consumable dispensed in an appliance, and activating a low consumable alert in response to a difference between the established volume of consumable and the determined volume of dispensed consumable being less than a threshold volume.

In a second example embodiment, a method for monitoring usage of a consumable in an appliance includes optically scanning a consumable container with a reader of a mobile computing device, establishing a volume of consumable within the consumable container based upon the optical scan of the consumable container by the reader, and determining a volume of consumable dispensed in an appliance. In response to a difference between the established volume of consumable and the determined volume of dispensed consumable being less than a threshold volume, the method also includes performing one or more of (1) activating a low consumable alert, and (2) automatically purchasing another consumable container filled with the consumable.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 is a schematic view of a system for monitoring usage of a consumable in an appliance according to an example embodiment of the present subject matter.

FIG. 2 is a schematic view of an appliance of the example consumable usage monitoring system of FIG. 1.

FIG. 3 is a schematic view of a consumable container according to an example embodiment of the present subject matter.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

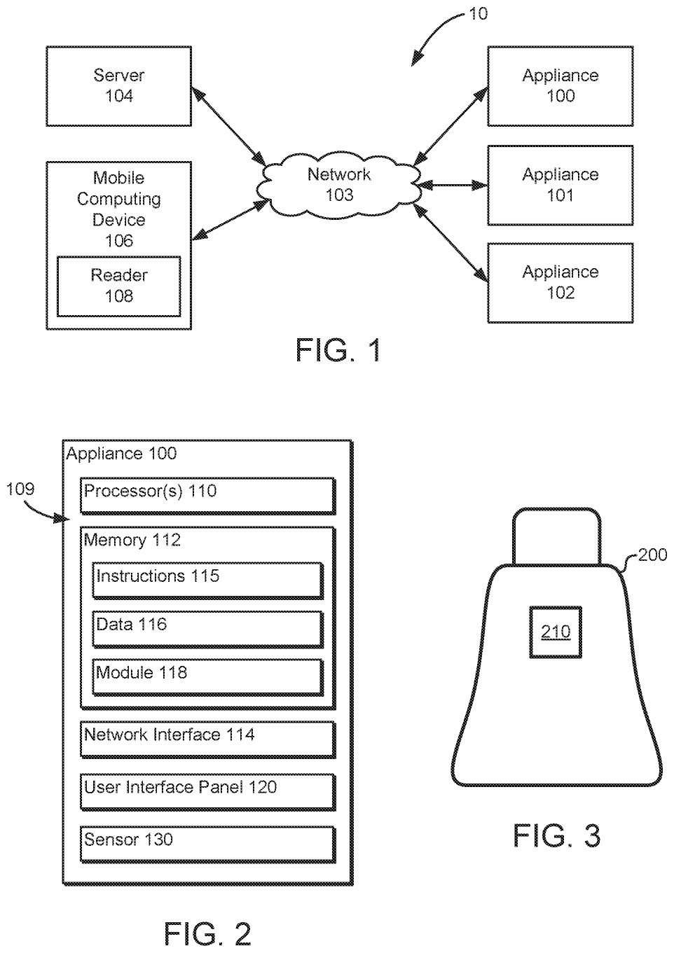

FIG. 1 is a schematic view of a consumable usage monitoring system 10 according to an example aspect of the present subject matter. Consumable usage monitoring system 10 includes a plurality of network connected appliances. In FIG. 1, consumable usage monitoring system 10 includes three network connected appliances: a first appliance 100; a second appliance 101; and a third appliance 102. However, it will be understood that consumable usage monitoring system 10 may include any suitable number of network connected appliances, e.g., two, four, five or more network connected appliances, in alternative example embodiments. Each of the network connected appliances in consumable usage monitoring system 10 may be any suitable type of network connected appliance. For example, each network connected appliance may be one of a washing machine appliance, a dishwasher appliance, a dryer appliance, etc.

FIG. 2 is a schematic view of appliance 100 of consumable usage monitoring system 10. Although only appliance 100 is described in greater detail below, each of the network connected appliances (e.g., appliance 101 and/or appliance 102) in consumable usage monitoring system 10 may include some or all of the components described below for appliance 100.

Appliance 100 is connectable to a network 103. Thus, e.g., appliance 100 may communicate with a server 104 via network 103. In particular, appliance 100 may transmit data, e.g., related to operation of appliance 100, from appliance 100 to server 104 or other network connected appliances in consumable usage monitoring system 10 via network 103. As discussed in greater detail below, consumable usage monitoring system 100 may assist with monitoring usage of a consumable in appliance 100.

Appliance 100 includes one or more processors 110, a memory 112, and a network interface 114. Network interface 114 of appliance 100 can include any suitable components for interfacing with one more networks, such as network 103. For example, network interface 114 of appliance 100 may include transmitters, receivers, ports, controllers, antennas, or other suitable components.

Network interface 114 may establish communication with network 103 via a connection through any suitable medium, e.g., wired or wireless. Network 103 may be any type of communications network, such as a local area network (e.g. intranet), wide area network (e.g. Internet), or some combination thereof. In general, communication between controller 109 and network 103 may be carried via associated network interfaces using any type of connection, using a variety of communication protocols (e.g. TCP/IP, HTTP), encodings or formats (e.g. HTML, XML), and/or protection schemes (e.g. VPN, secure HTTP, SSL). In particular, the network 103 may be a wireless local area network (WLAN) configured to conform to IEEE 802.11.

The processor(s) 110 of appliance 100 can be any suitable processing device, such as a microprocessor, microcontroller, integrated circuit, or other suitable processing device. The memory 112 of appliance 100 can include any suitable computing system or media, including, but not limited to, non-transitory computer-readable media, RAM, ROM, hard drives, flash drives, or other memory devices. The memory 112 of appliance 100 can store information accessible by processor(s) 110 of appliance 100, including instructions 115 that can be executed by processor(s) 110 to control various components of appliance 100 to provide appliance functionality and data 116. Thus, the combination of one or more processors 110 and memory 112 may correspond to a controller configured to implement various programs or methods to operate appliance 100, and processors 110 and memory 112 may be collectively referred to herein as a controller 109. Input/output (“I/O”) signals may be routed between controller 109 and various operational components of appliance 100 along wiring harnesses that may be routed within appliance 100.

A module 118 is included or stored in memory 112 of appliance 100. It will be appreciated that the term “module” refers to computer logic utilized to provide desired functionality. Thus, a module can be implemented in hardware, application specific circuits, firmware and/or software controlling a general purpose processor. In one embodiment, modules are program code files stored on the storage device, loaded into memory and executed by a processor or can be provided from computer program products, for example computer executable instructions, that are stored in a tangible computer-readable storage medium such as RAM, hard disk or optical or magnetic media. Thus, while module 118 is shown stored in memory 112 of appliance 100 in the example embodiment shown in FIG. 1, module 118 may be stored in or implemented by any other suitable component of system 100 in alternative example embodiments.

Appliance 100 also includes a user interface panel 120. User interface panel 120 is located within convenient reach of a user of appliance 100. User interface panel 120 includes various input components, such as one or more of a variety of touch-type controls, electrical, mechanical or electro-mechanical input devices including knobs, rotary dials, push buttons, and touch pads. The user interface panel 120 may include a display component, such as a digital or analog display device, designed to provide operational feedback to a user. Various appliance features of appliance 100 may be activated/deactivated by a user manipulating the input components on user interface panel 120. Thus, e.g., when appliance 100 is a washing machine appliance, a user may manipulate knobs or buttons on user interface panel 120 to activate and deactivate a wash cycle of the appliance.

As may be seen in FIG. 1, a computing device 106 is connectable to a network 103. Thus, e.g., computing device 106 may communicate with appliance 100 and/or server 104 via network 103. As an example, computing device 106 may transmit user command inputs to appliance 100 and/or server 104 via network 103. Thus, computing device 106 may include suitable input components, such as touch-type controls, electrical, mechanical or electro-mechanical input devices, etc. As another example, computing device 106 may receive video, audio and/or text data from server 104 via network 103 and display such data to a user of computing device 106. Thus, computing device 106 may include a suitable display, such as a digital or analog display. As may be seen from the above, computing device 106 is network connected and includes user inputs and a display. Thus, e.g., computing device 106 may be a smartphone, tablet, network connected television, etc. that allows display of data from network 103 and transmission of user inputs over network 103.

Computing device 106 also includes a reader 108, such as a camera, bar code scanner, QR-code scanner, etc. Reader 108 is operable to optically scan an object. In particular, reader 108 is operable to optically scan a consumable container, such as the consumable container 200 shown in FIG. 3. Consumable container 200 holds a volume of consumable fluid within consumable container 200. For example, consumable container 200 may hold detergent, fabric softener, dishwasher rinse aid, dryer sheets, etc. Reader 108 may generate a signal that corresponds to an optical scan of consumable container 200. Thus, e.g., reader 108 may generate a signal that corresponds to a code 210, such as a bar code or QR-code, on consumable container 200. As another example, reader 108 may generate a signal that corresponds to an image or picture of consumable container 200.

Various features of consumable usage monitoring system 10 are described in greater detail below in the context of consumable container 200. However, it will be understood that consumable container 200 is provided by way of example only and that consumable usage monitoring system 10 may be used with any suitable container in alternative example embodiments.

Utilizing the optical scan of consumable container 200 from reader 108, consumable usage monitoring system 10 may determine a volume of consumable within consumable container 200. For example, code 210 on consumable container 200 may include the volume of consumable within consumable container 200. Thus, when reader 108 optically scans consumable container 200, the volume of consumable within consumable container 200 may be read from code 210 by reader 108. As another example, image recognition may be used on an image of consumable container 200 from reader 108, and the image recognition may identify consumable container 200. After identifying the consumable container 200, the volume of consumable within consumable container 200 may be determined, e.g., using a lookup table, database, etc. over network 103.

Consumable usage monitoring system 10 also includes features for determining a volume of consumable dispensed in appliance 100. Thus, e.g., after establishing the volume of consumable within consumable container 200, consumable usage monitoring system 10 may then monitor the usage of the consumable from consumable container 200 in appliance 100. As shown in FIG. 2, appliance 100 may include a sensor 130. Sensor 130 may be operable to measure the volume of consumable within a bulk dispense tank of appliance 100. Thus, e.g., after loading the consumable from consumable container 200 into the bulk dispense tank of appliance 100, sensor 130 may track the usage of the consumable from the bulk dispense tank of appliance 100. In such example embodiments, sensor 130 may be a weight sensor for measuring a weight of the bulk dispense tank, an optical or float sensor for measuring a level of the consumable within the bulk dispense tank, a flow meter for measuring the flow rate of consumable from the bulk dispense tank, etc.

In alternative example embodiments, controller 109 of appliance 100 may track the number of consumable utilizing cycles run by appliance 100, e.g., after establishing the volume of consumable within consumable container 200. The volume of consumable dispensed in appliance 100 may then be established by calculating a product of the number of consumable utilizing cycles run by appliance 100 and, e.g., an average consumable dispensed for each consumable utilizing cycle. For example, when appliance 100 is a washing machine appliance, a volume of detergent, bleach and/or fabric softener may be used for each consumable utilizing cycle, and the average volume of the consumable dispensed for each consumable utilizing cycle may be stored in controller 109. Thus, the average consumable used for each consumable utilizing cycle of appliance 100 may be predetermined.

Consumable usage monitoring system 10 also includes features for activating a low consumable alert in response to a difference between the established volume of consumable and the determined volume of dispensed consumable being less than a threshold volume. The threshold volume may be a suitable volume for advantageously providing a buffer to avoid depletion of all the consumable. For example, the threshold volume may be no more than five percent (5%) remaining consumable, no more than ten percent (10%) remaining consumable, or no more than twenty-five percent (25%) remaining consumable.

As may be seen from the above, when the volume of consumable within consumable container 200 is exhausted or almost exhausted, consumable usage monitoring system 10 may alert the user of appliance 100 that additional consumable is needed for future operations of appliance 100. As an example, controller 109 may present a message on user interface panel 120 that informs the user that the current supply of consumable from consumable container 200 is exhausted or nearly exhausted. As another example, consumable usage monitoring system 10 may transmit a text message, a push alert and/or email to the user of appliance 100, e.g., to computing device 10, via network 103 that informs the user that the current supply of consumable from consumable container 200 is exhausted or nearly exhausted.

In addition or alternatively, consumable usage monitoring system 10 may include features for automatically purchasing another consumable container 200 filled with the consumable in response to the difference between the established volume of consumable and the determined volume of dispensed consumable being less than the threshold volume. Thus, using network 103, another consumable container 200 may be automatically purchased by consumable usage monitoring system 10 when the current supply of consumable from consumable container 200 is exhausted or nearly exhausted.

An example method for monitoring usage of a consumable by appliance 100 will now be described. It will be understood that while discussed below in a certain sequence, the method may be performed in other suitable sequences in alternative example embodiments. Thus, the method is not limited to the particular sequence described below.

Initially, consumable container 200 is optically scanned with reader 108 of computing device 106. In particular, reader 108 may optically scan the code 210 on consumable container 200 after a user purchases consumable container 200. Based upon information in the code 210 on consumable container 200, the quantity of consumable in consumable container 200 is determined. The determined quantity of consumable in consumable container 200 may then be stored on server 104 and/or the user's account may be updated with the determined quantity of consumable in consumable container 200.

After determining the quantity of consumable in consumable container 200, appliance 100 may track usage of the consumable in consumable container 200. For example, with appliance 100 connected to network 103, appliance 100 may count cycles ran and/or measure consumable usage with sensor 130 to establish a quantity of consumable used by appliance 100. The established quantity of consumable used by appliance 100 may be storage in server 104, an app, or appliance 100.

The established quantity of consumable used by appliance 100 is then compared to the determined quantity of consumable in consumable container 200. In such a manner, it may be determined when the user is running low on consumable for appliance 100. Consumable usage monitoring system 10 may alert the user to purchase additional consumable and/or automatically place an order for more consumable when the consumable for appliance 100 is running low.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A method for monitoring usage of a consumable in an appliance, comprising:
optically scanning a consumable container with a reader of a mobile computing device;
establishing a volume of consumable within the consumable container based upon the optical scan of the consumable container by the reader;
determining a volume of consumable dispensed in an appliance; and
activating a low consumable alert in response to a difference between the established volume of consumable and the determined volume of dispensed consumable being less than a threshold volume.

2. The method of claim 1, wherein the consumable is detergent, fabric softener, dishwasher rinse aid, or dryer sheets.

3. The method of claim 1, wherein the reader is camera on the mobile computing device.

4. The method of claim 3, wherein the camera captures an image of a bar code or a QR-code on the consumable container when the camera optically scans the consumable container.

5. The method of claim 4, wherein the bar code or the QR-code include the volume of consumable within the consumable container.

6. The method of claim 3, wherein the volume of consumable within the consumable container is established by image recognition on an image of the consumable container from the camera.

7. The method of claim 1, wherein the volume of consumable dispensed in the appliance is determined by a sensor in the appliance that measures the volume of consumable in a bulk dispense tank of the appliance.

8. The method of claim 1, wherein the volume of consumable dispensed in the appliance is determined by tracking a number of consumable utilizing cycles run by the appliance.

9. The method of claim 1, further comprising storing the established volume of consumable and the determined volume of dispensed consumable on a server connected to the mobile computing device and the appliance over a wireless network.

10. The method of claim 9, further comprising calculating the difference between the established volume of consumable and the determined volume of dispensed consumable on the server.

11. The method of claim 1, further comprising automatically purchasing another consumable container filled with the consumable in response to the difference between the established volume of consumable and the determined volume of dispensed consumable being less than the threshold volume.

12. The method of claim 1, wherein the low consumable alert is one or more of a text message, an email or a push alert.

13. A method for monitoring usage of a consumable in an appliance, comprising:
optically scanning a consumable container with a reader of a mobile computing device;
establishing a volume of consumable within the consumable container based upon the optical scan of the consumable container by the reader;
determining a volume of consumable dispensed in an appliance; and
in response to a difference between the established volume of consumable and the determined volume of dispensed consumable being less than a threshold volume, performing one or more of
(1) activating a low consumable alert, and
(2) automatically purchasing another consumable container filled with the consumable.

14. The method of claim 13, wherein the consumable is detergent, fabric softener, dishwasher rinse aid, or dryer sheets.

15. The method of claim 13, wherein the reader is camera on the mobile computing device.

16. The method of claim 15, wherein the camera captures an image of a bar code or a QR-code on the consumable container when the camera optically scans the consumable container, and the bar code or the QR-code include the volume of consumable within the consumable container.

17. The method of claim 15, wherein the volume of consumable within the consumable container is established by image recognition on an image of the consumable container from the camera.

18. The method of claim 13, wherein the volume of consumable dispensed in the appliance is determined by a sensor in the appliance that measures the volume of consumable in a bulk dispense tank of the appliance.

19. The method of claim 13, wherein the volume of consumable dispensed in the appliance is determined by tracking a number of consumable utilizing cycles run by the appliance.

20. The method of claim 13, further comprising storing the established volume of consumable and the determined volume of dispensed consumable on a server connected to the mobile computing device and the appliance over a wireless network.
